(19) United States
(12) Patent Application Publication
(10) Pub. No.: US 2025/0290814 A1
(43) Pub. Date: Sep. 18, 2025

(54) SENSOR MODULE

(71) Applicant: AUTONICS CORPORATION, Busan (KR)

(72) Inventors: Do Ick HWANG, Incheon (KR); Seung Young LEE, Seoul (KR); Ho Jung LEE, Siheung-si (KR); Jin Woong KIM, Incheon (KR)

(73) Assignee: AUTONICS CORPORATION, Busan (KR)

(21) Appl. No.: 18/860,330

(22) PCT Filed: Apr. 25, 2023
(86) PCT No.: PCT/KR2023/005607

§ 371 Date: Oct. 25, 2024

(30) Foreign Application Priority Data
Apr. 26, 2022 (KR) 10-2022-0051604
Dec. 26, 2022 (KR) 10-2022-0184648

(51) Int. Cl. G01L 9/00

(52) U.S. Cl. CPC G01L 9/0051

(57) ABSTRACT

A sensor module according to an embodiment of the present disclosure includes a pressure sensing part for sensing pressure; at least one or a plurality of PCB substrates for receiving the pressure signal sensed by the pressure sensing part, processing the pressure signal, and then outputting the signal; and a case accommodating the at least one or a plurality of PCB substrates and coupled to an upper end of the pressure sensing part; in which the pressure sensing part includes a sensing port in which a communication hole for pressure transmission is formed; and a pressure sensing element placed on an inner upper side of the sensing port and sensing a change in pressure transmitted through the communication hole; the pressure sensing element includes a diaphragm including a horizontal sensing surface and a support part extending vertically from an edge of the sensing surface; and one or more strain gauges placed on the sensing surface to sense a change in pressure transmitted through the communication hole; and the outer circumferential surface of the support part is formed with a groove recessed to a predetermined depth.

### TECHNICAL FIELD

The present disclosure relates to a sensor module, and more particularly to a sensor module for sensing pressure used to sense pressure.

### BACKGROUND ART

A sensor module used to sense pressure means a pressure measuring device based on a pressure sensing element such as a strain gauge and may be also defined as a pressure transmitter.

A general sensor module for sensing pressure uses a principle in which the deflection of a diaphragm generates an output of a strain gauge, and is a widely used technology field including automobiles, environmental facilities, medical devices, and semi-conductor industries.

The sensor module disclosed in Korean Patent Registration No. 10-1794919 (Nov. 1, 2017) (Prior Art 1) has a structure in which another PCB substrate is vertically coupled to an upper surface of a PCB substrate placed horizontally. The conventional sensor module according to this structure has a problem in that the coupling stability of the PCB assembly is poor.

In addition, the conventional pressure sensor module including the sensor module disclosed in Korean Patent Publication No. 2015-0052599 (May 14, 2015) (Prior Art 2) has a structure to prevent leak pressure of the pressure measuring part by processing a diaphragm and a body accommodating the diaphragm as a single body. In a case of a structure in which the diaphragm and the body are formed as a single body, it is difficult to process the diaphragm as a thin film and it is impossible to process the side to increase sensing sensitivity.

In addition, in the case of the conventional single body structure, when the strain gauge is bonded to the diaphragm, there is a disadvantage in that an oxide film is formed on the outer appearance of the product due to high-temperature firing.

Furthermore, the conventional sensor module including the prior art 1 has a disadvantage in that it is difficult to assemble because there is no component that determines the direction when assembling the PCB.

In addition, in a case of a structure in which only circular components are coupled to the inside of a cylindrical case, when rotational force is applied to the pin connector of the sensor module, there is a high possibility that the internal PCB or the like may be damaged due to rotation.

In addition, since internal components are assembled through bonding to prevent components from being damaged by rotational force and to maintain airtightness, there is a disadvantage in that it is difficult to expect quantitative quality with variables such as the amount of adhesive applied and curing conditions.

### DISCLOSURE OF INVENTION

### Technical Problem

The present disclosure is proposed to improve the above problems.

### Solution to Problem

A sensor module according to an embodiment of the present disclosure for achieving the above object includes a pressure sensing part for sensing pressure; at least one or a plurality of PCB substrates for receiving the pressure signal sensed by the pressure sensing part, processing the pressure signal, and then outputting the signal; and a case accommodating the at least one or a plurality of PCB substrates and coupled to an upper end of the pressure sensing part; in which the pressure sensing part includes a sensing port in which a communication hole for pressure transmission is formed; and a pressure sensing element placed on an inner upper side of the sensing port and sensing a change in pressure transmitted through the communication hole; the pressure sensing element includes a diaphragm including a horizontal sensing surface and a support part extending vertically from an edge of the sensing surface; and one or more strain gauges placed on the sensing surface to sense a change in pressure transmitted through the communication hole; and the outer circumferential surface of the support part is formed with a groove recessed to a predetermined depth.

Rounded parts are formed in an upper end and a lower end of the groove, respectively.

The diaphragm further includes a shoulder extending in a radial direction from the lower end of the support; and a body extending downward from a bottom surface of the shoulder, and inner diameters of the support part, the shoulder, and the body are the same.

The outer diameter of the body is larger than an outer diameter of the support part and smaller than an outer diameter of the shoulder.

The diaphragm further includes a boss protruding from a lower surface of the sensing surface.

The boss protrudes from the center of the sensing surface and is located directly above the communication hole.

The sensing port includes a pot main body in which the communication hole is formed; and a flange formed on the upper end of the pot main body, and the diaphragm accommodation groove in which the diaphragm is accommodated is recessed to a predetermined depth from the upper surface of the flange to the lower side.

The lower end of the body is seated in the diaphragm accommodation groove, a protrusion protrudes from the bottom of the diaphragm accommodation groove, and the communication hole passes through the protrusion.

The protrusion tapers in a direction in which the diameter decreases toward the upper end, and the inner lower end portion of the body touches the lower end of the protrusion.

A snubber coupling groove is recessed from the lower end to the upper end of the sensing port, and the lower end of the communication hole is connected to the snubber coupling groove.

The pressure sensing part further includes a snubber inserted at a lower end of the sensing port.

Inside the buffer, a wrench groove recessed upward from the lower end of the snubber; and a pressure reducing slit extending from the center of the upper surface of the wrench groove to the upper end of the snubber are formed.

Threads are formed on the outer circumferential surface of the snubber and the inner circumferential surface of the snubber coupling groove, respectively, and thus the snubber is screwed into the snubber coupling groove.

The lower end of the body is welded to the bottom of the diaphragm accommodation groove.

### Advantageous Effects of Invention

The sensor module according to the embodiment of the present disclosure having the above configuration has the following effects.
1. There is an advantage in that, by installing ground pins made of metal with strong shear force at multiple points in the axial direction of the sensor module, when an external force including a rotational force acts on an external component wired to an internal circuit component, damage to the wiring of internal components may be minimized.
2. By not adopting a bond application method for preventing internal components from rotating, there is an advantage in that uniform quality can be maintained and the manufacturing process can be shortened.
3. Since grooves or holes through which a plurality of ground pins pass are formed in the PCB substrate, there is an effect in that an assembly position of the PCB substrate is accurately determined, and thus reverse assembly or misassembly between components is prevented.
4. Since the diaphragm and the sensing port are manufactured separately and then joined by welding, there is an advantage in that it is easy to process a groove on the side of the diaphragm to increase sensing sensitivity. In addition, since the sensing port is not inserted into the firing furnace when the strain gauge is attached to the diaphragm, there is an advantage in that an oxide film is not formed on the outer appearance of the sensing port.
5. By forming the groove on the side part of the diaphragm, the thermal strain of the sensing surface due to temperature change is reduced, thereby reducing the offset change rate according to temperature. In addition, more stable pressure is applied to the sensing surface, so that the strain rate increases and the output value of the strain gauge increases according to the pressure application, thereby improving the precision of the pressure sensor.
6. Since the boss is formed on the lower surface of the sensing surface, strain distribution due to pressure change increases or decreases linearly, thereby increasing the linearity of strain. Furthermore, there is an advantage in that the durability of the sensor module is improved by increasing the safety factor of the diaphragm due to the relative diaphragm displacement and stress reduction. In addition, since the boss is formed on the lower surface of the sensing surface, the strain rate of the sensing surface increases, thereby increasing the output value of the strain gauge and reducing the error rate.
7. Since the snubber is provided, irregular pulsation pressure due to valve on/off is alleviated, thereby reducing the possibility of damage to the sensing surface, thereby improving durability.
8. The boss protruding from the bottom of the accommodation groove where the diaphragm is seated is in the shape of a truncated cone, and the lower end part of the diaphragm is made in the shape of a ring, so there is no need for a separate mechanism to fix the diaphragm during welding.
9. Since the snubber is screwed to the sensing port instead of press-fitting, there is an advantage in that risk factors occurring in the press-fitting process are eliminated.

### BRIEF DESCRIPTION OF DRAWINGS

FIG. 1 is an outer appearance perspective view illustrating a sensor module according to an embodiment of the present disclosure.

FIG. 2 is an exploded perspective view illustrating the sensor module.

FIG. 3 is a longitudinal sectional view of the sensor module taken along line 3-3 in FIG. 1.

FIG. 4 is a longitudinal sectional view of a sensor module according to an embodiment of the present disclosure taken along line 4-4 of FIG. 1.

FIG. 5 is a perspective view illustrating the outer appearance of the sensor module from which a case and a cover are removed.

FIG. 6 is a perspective view illustrating a coupled state of a spacer, a ground terminal, and a ground pin according to an embodiment of the present disclosure.

FIG. 7 is a perspective view illustrating a spacer viewed from one side.

FIG. 8 is a perspective view illustrating a spacer viewed from the other side.

FIG. 9 is a perspective view illustrating a signal input substrate mounted on a sensor module according to an embodiment of the present disclosure.

FIG. 10 is a perspective view illustrating a signal processing substrate mounted on a sensor module according to an embodiment of the present disclosure.

FIG. 11 is a bottom perspective view illustrating a signal output substrate mounted on a sensor module according to an embodiment of the present disclosure.

FIG. 12 is a perspective view illustrating a ground terminal provided in a sensor module according to an embodiment of the present disclosure.

FIG. 13 is a perspective view illustrating a pressure sensing part according to an embodiment of the present disclosure.

FIG. 14 is an exploded perspective view illustrating the pressure sensing part.

FIG. 15 is a longitudinal cross-sectional view of the pressure sensing part taken along line 15-15 in FIG. 13.

FIG. 16 is an enlarged view illustrating a part A of FIG. 15.

FIG. 17 is a view illustrating a comparison between strain distribution in the case where a boss is present in a diaphragm and strain distribution in the case where a boss is not present in a diaphragm.

### MODE FOR THE INVENTION

Hereinafter, a sensor module according to an embodiment of the present disclosure will be described in detail with reference to the drawings.

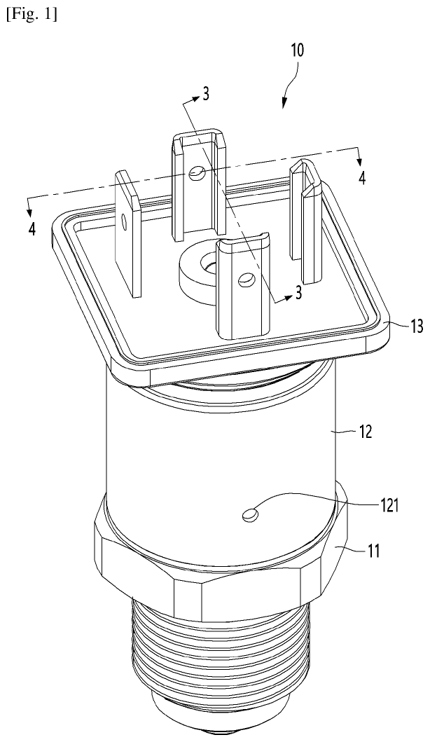

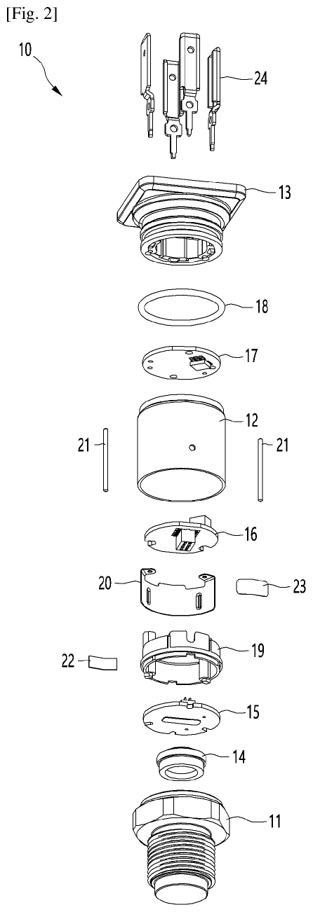

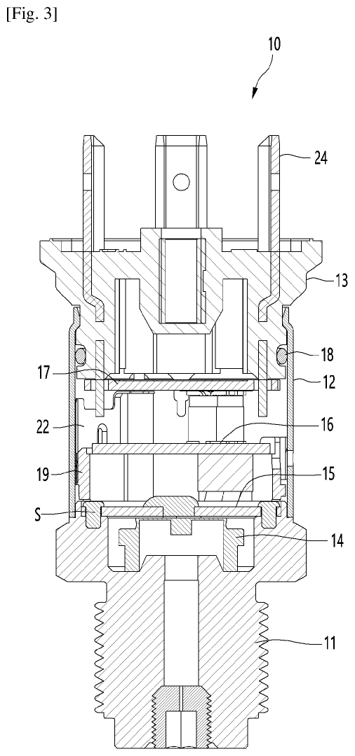

FIG. 1 is an outer appearance perspective view illustrating a sensor module according to an embodiment of the present disclosure, FIG. 2 is an exploded perspective view illustrating the sensor module, FIG. 3 is a longitudinal sectional view of the sensor module taken along line 3-3 in FIG. 1.

Referring to FIGS. 1 to 3, the sensor module 10 according to an embodiment of the present disclosure includes a case 12 in the shape of a hollow cylinder, a pressure sensing part coupled to the lower end of the case 12, and a cover 13 coupled to the upper end of the case 12.

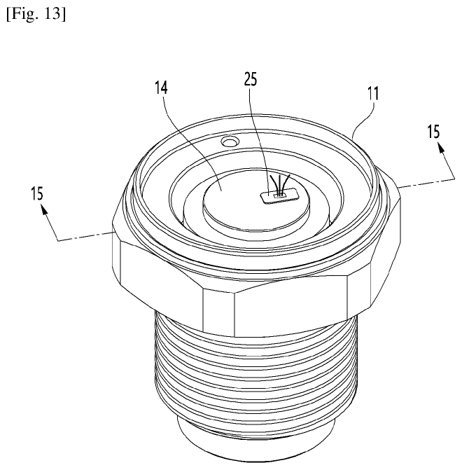

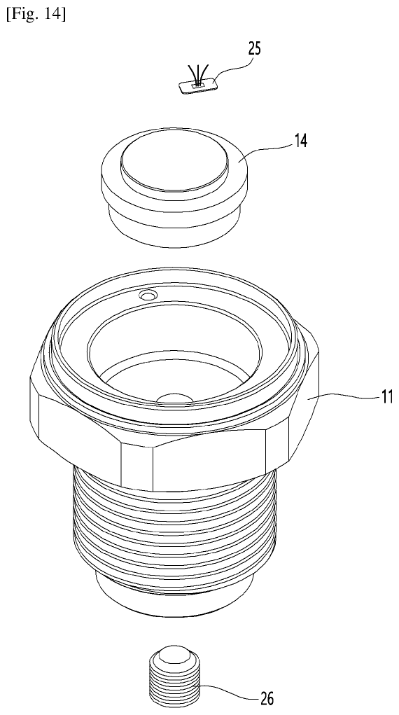

In detail, the pressure sensing part may include a sensing port 11 and a diaphragm 14 mounted to the sensing port 11. One or more strain gauges 25 (see FIG. 13) are mounted on the diaphragm 14 to sense a change in pressure transmitted to the inside of the sensing port 11. A combination of the diaphragm 14 and the strain gauge 25 may be defined as a pressure sensing element.

In addition, the sensor module 10 further includes a plurality of PCB substrates for reading, processing, and outputting pressure sensing signals transmitted from the pressure sensing part to the outside, and spacers 19 supporting the plurality of PCB substrates. The function and operation of the spacer 19 will be described in more detail with reference to the drawings below.

The plurality of PCB substrates may include a first substrate 15 positioned directly above the diaphragm 14 and a second substrate 16 positioned inside the spacer 19.

The plurality of PCB substrates may further include a third substrate 17 placed on the upper end of the spacer 19, selectively according to product design conditions.

In addition, the first substrate 15 may be defined as a signal input substrate, the second substrate may be defined as a signal processing substrate, and the third substrate may be defined as a signal output substrate.

In detail, the pressure signal coming from the pressure sensing part is read from the first substrate 15, and the signal transmitted from the first substrate 15 is processed by the second substrate 16. In addition, the pressure measurement value processed by the second substrate 16 is output to the outside from the third substrate 17.

In addition, the sensor module 10 further includes a ground terminal 20 coupled to an outer surface of the spacer 19. An inner circumferential surface of the ground terminal 20 may be coupled to an outer circumferential surface of the spacer 19 by an adhesive member 22 such as double-sided tape.

The sensor module 10 may further include a membrane 23. In detail, a communication hole 121 is formed in the case 11 to allow air to circulate between the inside and outside of the case 12 so that air pressure inside and outside the case is balanced.

In addition, the air introduced through the communication hole 121 passes through the membrane 23 and the moisture contained in the air is filtered so that only air is introduced into the case 12. As a result, it is possible to prevent an electrical problem from occurring in the plurality of PCB substrates due to moisture.

The sensor module 10 further includes a ground pin 21 inserted into the spacer 19. Damage to internal circuit components and other internal components is prevented from external rotational force applied to the sensor module 10 by the ground pin 21. A pair of ground pins 21 may be provided.

The sensor module 10 may further include a seal ring 18 provided at a close contact between the case 12 and the cover 13. The seal ring 18 may be an O-ring, but is not limited thereto.

One or a plurality of terminal pins 24 may be inserted into the cover 13.

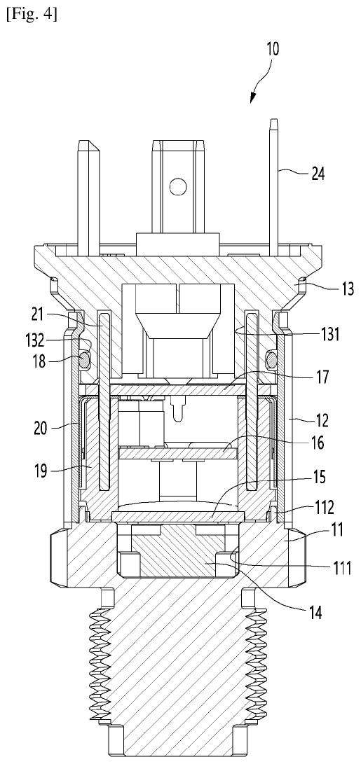

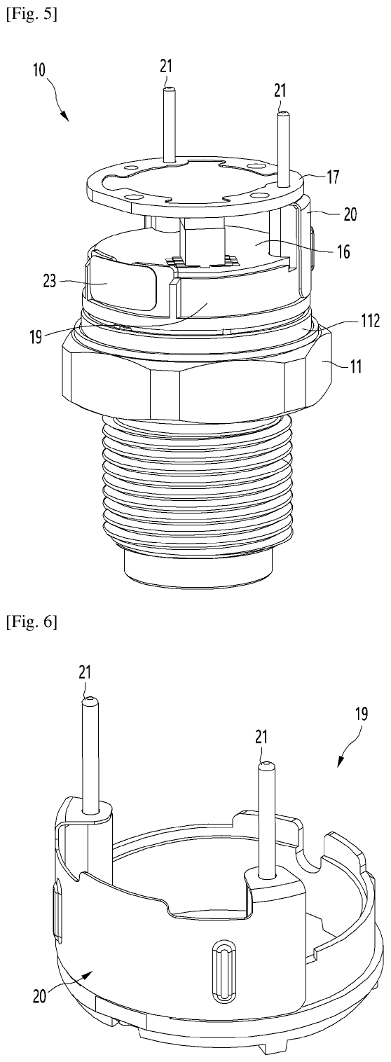

FIG. 4 is a longitudinal sectional view of a sensor module according to an embodiment of the present disclosure taken along line 4-4 of FIG. 1, and FIG. 5 is a perspective view illustrating the outer appearance of the sensor module from which a case and a cover are removed.

Referring to FIGS. 4 and 5, a pin insertion hole 131 into which an upper part of the ground pin 21 is inserted is formed in the cover 13 constituting the sensor module 10 according to the embodiment of the present disclosure. In addition, a sealing groove 132 into which the seal ring 18 is fitted is formed on a side surface of the cover 13. The depth of the sealing groove 132 is smaller than the diameter of the sealing ring 18, so that when the cover 13 is fitted to the upper side of the case 12, the outer surface of the sealing ring 18 is in close contact with the inner surface of the case 12.

The ground pin 21 protrudes further from the upper surface of the spacer 19 by a predetermined length while being inserted into the spacer 19, and penetrates the third substrate 17 placed on the upper end of the spacer 19, and then is inserted into the pin insertion hole 131 of the cover 13.

The ground pin 21 is made of a conductor having high shear strength and functions as a passage that facilitates the movement of charges, thereby preventing malfunction of the sensor module 10 and damage to components due to introduction of static electricity or abnormal charges. As an example, the ground pin 21 may be made of a metal material.

A recessed part 111 accommodating the diaphragm 14 may be formed in the sensing port 11. The recessed part 111 may have a predetermined diameter and may be provided in a shape that is recessed to a predetermined depth from the upper surface of the sensing port 11 to the lower side.

In addition, a support sleeve 112 extends from the upper surface of the sensing port 11, and the first substrate 15 is placed inside the support sleeve 112.

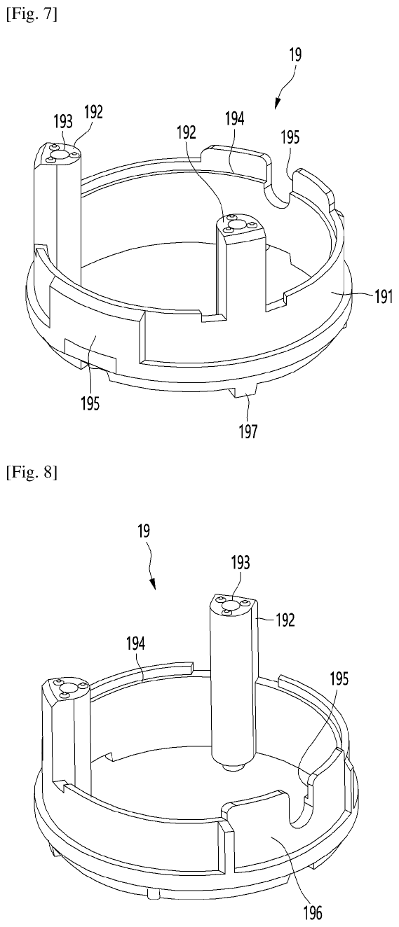

FIG. 6 is a perspective view illustrating a coupled state of a spacer, a ground terminal, and a ground pin according to an embodiment of the present disclosure, FIG. 7 is a perspective view illustrating a spacer viewed from one side, and FIG. 8 is a perspective view illustrating a spacer viewed from the other side.

Referring to FIG. 6, the ground terminal 20 is coupled to the outer circumferential surface of the spacer 19, and the ground pin 21 penetrates a part of the ground terminal 20 and is inserted into the spacer 19.

Referring to FIGS. 7 and 8, the spacer 19 includes a body 191 and a pin support boss 192 extending upward from the body 191. For example, the body 191 may have a cylindrical shape or a sleeve shape having a predetermined height. A pair of the pin support bosses 192 may be provided.

In detail, the pair of pin support bosses 122 are formed at positions spaced apart from each other at an angle smaller than 180 degrees in the circumferential direction of the body 191.

More specifically, the angle formed by a line connecting one of the pair of pin support bosses 122 and the center of the body 191 and a line connecting the other one of the pair of pin support bosses 122 and the center of the body 191 is less than 180 degrees, and may be, for example, 120 degrees.

A pin insertion groove 193 is formed at the center of the pin support boss 192 to a predetermined depth, and the ground pin 21 is inserted into the pin insertion groove 193. The depth of the pin insertion groove 193 is smaller than the length of the ground pin 21.

The pin support boss 192 extending upward and the ground pin 21 inserted into the pin insertion groove 193 perform a guide function of determining the assembling direction of components having directionality during assembly including the plurality of PCB substrates. In addition, by the pin support boss 192 and the ground pin 21, it is possible to assemble a number of components in an accurate position, thereby enabling accurate coupling between connectors.

In addition, a part of the ground pin 21 may be inserted into the spacer 19, and particularly inserted into the pin support boss 122, thereby preventing the ground pin 21 from being bent by an external force. In addition, another part of the ground pin 21 is inserted into the cover 13. At this time, since the other part of the ground pin 21 passes through the ground terminal 20 and is inserted into the cover 13, it is possible to prevent the ground terminal 20 from being separated from the spacer 19.

In addition, a fixing protrusion 197 protrudes from the bottom surface of the body 191 corresponding to the lower end of the pin support boss 192 to accurately set the assembly position of the first substrate 15 and a phenomenon in which the first substrate 15 is spaced apart or separated from the assembly position is prevented.

An adhesive member seating part 195 is formed at a point on the outer circumferential surface of the body 191, and the adhesive member 22 is attached to the adhesive member seating part 195. As described above, the adhesive member 22 may be a double-sided tape, one side of the double-sided tape is attached to the body 191, and the other side thereof is attached to the inner circumferential surface of the ground terminal 20.

In addition, a communication hole 195 (or a communication groove) is formed at a point of the body 191 and is aligned with the communication hole 121 of the case 11. In addition, a membrane seating part 196 is formed at a part where the communication hole 195 is formed.

The membrane seating part 196 may be formed stepwise from the outer circumferential surface of the body 191 to a depth corresponding to the thickness of the membrane 23. In addition, the communication hole 195 may be formed at the center of the membrane seating part 196. In addition, the communication hole 195 may be formed to be recessed to a predetermined depth from the upper end of the body 191 to the lower side.

Meanwhile, a substrate seating jaw 194 is formed on an inner circumferential surface of the body 191, and the signal processing substrate 16 is seated on the substrate seating jaw 194. Further, the pin support boss 192 forms a cross-sectional size protruding from the inner circumferential surface of the body 191 toward the center, so that when the signal processing substrate 16 is seated on the substrate seating jaw 194, the signal processing substrate may be assembled in a set seating position or direction of the signal processing substrate 16.

The substrate seating jaw 194 is formed at a point spaced downward from the upper end of the body 191 and bisects the communication hole 195 in a vertical direction. Accordingly, in a state where the signal processing substrate 16 is placed on the substrate seating jaw 194, external air introducing into the communication hole 195 is divided into an upper side and a lower side of the signal processing substrate 16 to flow.

By forming the communication holes 195 and 121, the air pressure inside and outside the sensor module 10 is kept the same, so that precise pressure measurement is possible, and since air introducing into the communication hole 195 is divided into the upper part and lower part of the signal processing substrate 16, there is an advantage in that air circulation can be smoothly performed inside the sensor module 10.

In addition, since only air excluding moisture contained in the external air is introduced into the sensor module 10 by the membrane 23, there is no or significantly reduced possibility of causing electrical problems due to moisture in the internal components.

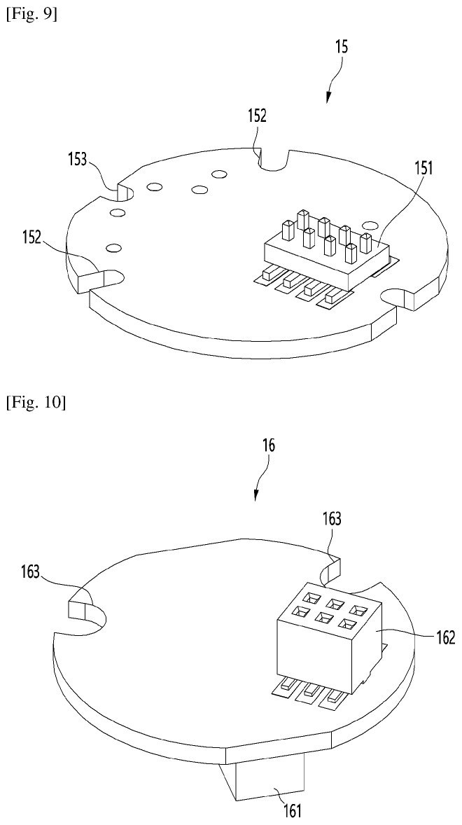

FIG. 9 is a perspective view illustrating a signal input substrate mounted on a sensor module according to an embodiment of the present disclosure.

In detail, the first substrate 15 may be placed on the upper surface of the sensing port 11 wherein the first substrate may be placed inside the support sleeve 112.

In addition, a connector 151 may be mounted on an upper surface of the first substrate 15, and a protrusion groove 151 and a fastening groove 153 may be formed at an edge of the first substrate 15. A pair of protrusion grooves 151 may be provided, and a plurality of fastening grooves 153 may be provided.

The protrusion groove 151 is a groove in which the fixing protrusion 197 protruding from the lower end of the spacer 19 is accommodated, and a fastening member is inserted into the fastening groove 153. A plurality of fastening grooves 153 may be provided, for example, two fastening grooves may be provided, and the two fastening grooves 153 may be formed at positions facing each other, but are not limited thereto.

The fastening member S passes through the fastening groove 153 and is inserted into the sensing port 11 so that the signal input substrate 15 is fixed to the sensing port 11. In addition, by fitting the fixing protrusion 197 into the pair of protrusion grooves 152 forming an angle of less than 180 degrees in the circumferential direction, the spacer 19 is automatically and accurately placed in the mounting position.

FIG. 10 is a perspective view illustrating a signal processing substrate mounted on a sensor module according to an embodiment of the present disclosure.

Referring to FIG. 10, the second substrate 16 is placed on the substrate seating jaw 194 and is spaced apart from the first substrate 15.

A lower connector 161 is mounted on the lower surface of the second substrate 16, and an upper connector 162 is mounted on the upper surface. In addition, the lower connector 161 is coupled to the connector 151 of the first substrate 15, and the lower connector 161 and the connector 151 are coupled in the inner space of the spacer 19.

In addition, a boss fitting groove 163 may be recessed at the edge of the second substrate 16. The boss fitting groove 163 is a groove in which the pin support boss 192 is accommodated. Thus, a pair of boss fitting grooves 163 may be provided.

The pin support boss 192 protrudes from the inner circumferential surface of the body 191 toward the center, and the protruding part is inserted into the boss fitting groove 163. As the pair of pin support bosses 192 are inserted into the pair of boss fitting grooves 163, the second substrate 16 is automatically placed in an accurate mounting position. As a result, when the second substrate 16 is placed on the substrate seating jaw 194, the lower connector 161 is accurately coupled to the connector 151 of the first substrate 15.

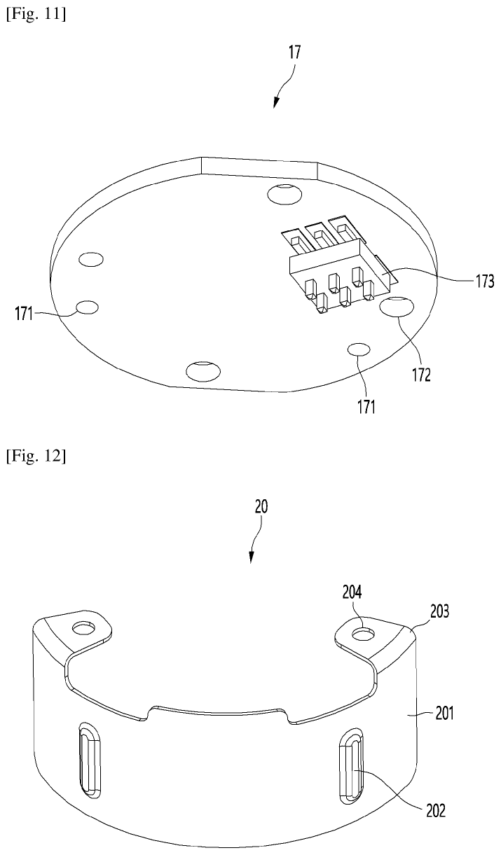

FIG. 11 is a bottom perspective view illustrating a signal output substrate mounted on a sensor module according to an embodiment of the present disclosure.

Referring to FIG. 11, a connector 173 coupled to the upper connector 162 is provided on the lower surface of the third substrate 17.

In detail, a pin insertion hole 171 and one or more fastening holes 172 are formed at the edge of the third substrate 17.

The pin insertion holes 171 are holes through which the pair of ground pins 21 inserted into the pair of pin support bosses 192 pass and are spaced apart at an angle of less than 180 degrees in the circumferential direction. A pair of pin insertion holes 171 may be provided.

As the ground pin 21 passes through the pin insertion hole 171, the third substrate 17 is automatically placed in an accurate mounting position.

As illustrated in FIG. 5, the third substrate 17 is placed horizontally on the upper surface of the pair of pin support bosses 192.

In addition, one or more terminal pins 24 pass through the cover 13 and are inserted into the one or more fastening holes 172 formed in the third substrate 17. Therefore, the third substrate 17 is simultaneously fixed to the cover 13 and the pin support boss 192.

FIG. 12 is a perspective view illustrating a ground terminal provided in a sensor module according to an embodiment of the present disclosure.

Referring to FIG. 12, the ground terminal 20 may be made of a metal material having electrical conductivity.

In detail, the ground terminal 20 includes a terminal body 201 rounded in a form surrounding a part of the outer circumferential surface of the spacer 19, and extension ends 203 extending and bending from both side edges of the upper end part of the terminal body 201. A pair of the extension ends 203 may be provided and may be spaced apart by an angle of less than 180 degrees in the circumferential direction of the terminal body 201. A pin insertion hole 204 is formed in the extension end 203.

The extension end 203 is seated on the upper surface of the pin support boss 192 so that the pin insertion hole 204 and the pin insertion hole 193 of the pin support boss 192 are aligned. The ground pin 21 passes through the pin insertion hole 204 and is inserted into the pin insertion hole 193.

By placing the extension end 203 on the upper end of the pin support boss 192, the ground terminal 20 is accurately placed in the mounting position. In addition, the ground terminal 20 is fixed to the spacer 19 by the adhesive member 21 interposed between the inner circumferential surface of the terminal body 201 and the outer circumferential surface of the spacer 19, further the ground terminal 20 is more stably fixed to the spacer 19 by the ground pin 21 passing through the hole 204.

Meanwhile, one or a plurality of protrusions 202 may protrude from the outer circumferential surface of the terminal body 201. The one or more protrusions 202 are in close contact with the inner circumferential surface of the case 11 to increase contact resistance. As a result, it is possible to minimize a phenomenon in which the ground terminal 20 fluctuates in the circumferential direction inside the case 11.

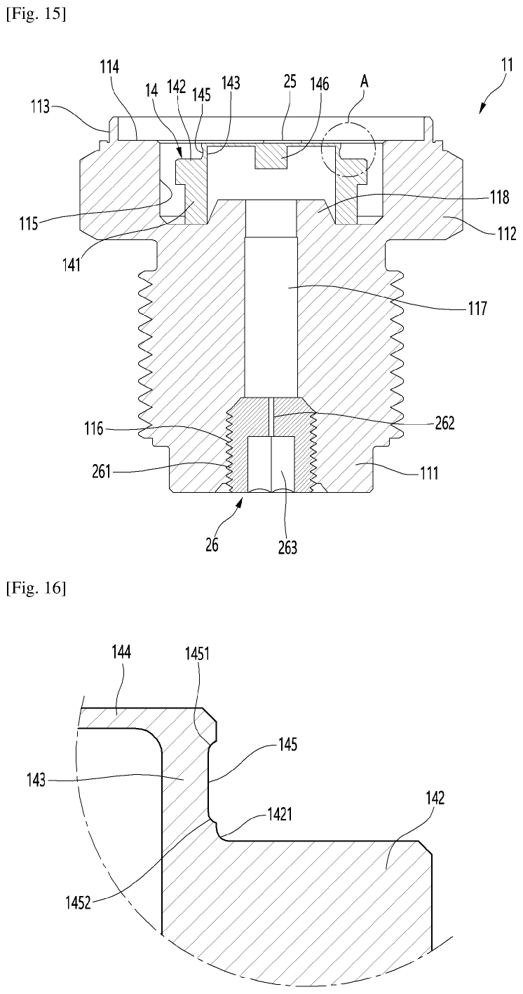

FIG. 13 is a perspective view illustrating a pressure sensing part according to an embodiment of the present disclosure, FIG. 14 is an exploded perspective view illustrating the pressure sensing part, and FIG. 15 is a longitudinal cross-sectional view of the pressure sensing part taken along line 15-15 in FIG. 13.

Referring to FIGS. 13 to 15, the pressure sensing part constituting the sensor module 10 according to the embodiment of the present disclosure includes a sensing port 11, a diaphragm 14, and a strain gauge 25.

In detail, the pressure sensing part may further include a snubber 26 fitted to the lower end of the sensing port 11.

More specifically, the sensing port 11 includes a port main body 111 and a flange 112 formed on an upper end of the port main body 111. The outer diameter of the flange 112 is designed to be larger than the outer diameter of the port main body 111, so that the sensing port 11 may have a T-shaped longitudinal cross-section.

A diaphragm accommodation groove 115 may be recessed to a predetermined depth inside the flange 112. A snubber coupling groove 116 and a communication hole 117 are formed inside the port main body 111, and the central axis of the port main body 111 is coaxial with the central axis of the central axis of the snubber coupling groove 116 and the central axis of the communication hole 117.

A screw thread is formed on the inner circumferential surface of the snubber coupling groove 116. The lower end of the communication hole 117 communicates with the upper end of the snubber coupling groove 116, and the upper end of the communication hole 117 communicates with the diaphragm accommodation groove 115.

A protrusion 118 protrudes from the bottom of the diaphragm accommodation groove 115, and the communication hole 117 passes through the protrusion 118. The protrusion 118 is formed in the shape of a truncated cone tapering in a direction in which the diameter decreases toward the upper end.

A circular sleeve 113 is formed on the upper surface of the flange 112 corresponding to the outside of the diaphragm accommodation groove 115, and the first substrate 15 and the spacer 19 are seated on the inside of the sleeve 113.

Meanwhile, the snubber 26 is inserted into the snubber coupling groove 116 and functions to prevent product damage due to pulsating pressure.

In detail, a screw thread 261 is formed on the outer circumferential surface of the snubber 26, and engages with the screw thread formed on the inner circumferential surface of the snubber coupling groove 116 to be thread-coupled to the port main body 111.

A wrench groove 263 and a pressure reducing slit 262 are formed inside the snubber 26. The pressure reducing slit 262 extends from the upper surface of the wrench groove 263 to the upper surface of the snubber 26, and when an abnormal pressure is introduced into the snubber 26, by allowing the abnormal pressure to pass through the pressure reducing slit 262, the pulsating pressure is relieved. As a result, a phenomenon in which the pressure sensing surface of the diaphragm 14 is damaged can be prevented. The snubber 26 may be made of a stainless material.

The diameter of the pressure reducing slit 262 is determined by the pressure range sensed by the sensor module 10. In other words, when the pressure range sensed by the sensor module 10 increases, the diameter of the pressure reducing slit 262 may increase, and when the pressure range sensed by the sensor module 10 decreases, the diameter of the pressure reducing slit 262 may decrease. In addition, the diameter of the pressure reducing slit 262 may be changed according to the response time of the sensor module 10. The response time of the sensor module 10 is fast when the diameter of the pressure reducing slit 262 is large, and the response time of the sensor module 10 becomes slow when the diameter of the pressure-reducing slit 262 is small.

The diaphragm 14 is seated in the diaphragm accommodation groove 115 and welded thereto.

In detail, the diaphragm 14 includes a cylindrical body 141, a shoulder 142 formed at an upper end of the body 141 and having a larger outer diameter than the outer diameter of the body 141, and, a support part 143 further extending upward from the upper surface of the shoulder 142, and a sensing surface 144 formed on an upper end of the support part 143.

The body 141, the shoulder 142, and the support part 143 may have a cylindrical shape having the same inner diameter. The thickness of the support part 143 may be smaller than that of the body 141.

One or more strain gauges 25 are attached to the upper surface of the sensing surface 144. In order to improve the withstand voltage performance of the one or more strain gauges 25 mounted on the upper surface of the sensing surface 144, silicone gel, silicone oil, or the like may be applied to a least a part of the sensing surface 144 and the strain gauges 25.

A groove 145 is formed around the outer circumferential surface of the support part 143 with a predetermined depth and width. By forming the groove 145, the thermal strain of the sensing surface 144 due to temperature change is reduced, and the offset change rate according to temperature is reduced. In addition, the applied pressure acts more stably on the sensing surface 144, so that the strain rate increases, and as the strain rate increases, the output value of the strain gauge 25 also increases, thereby improving accuracy.

The smaller the offset change rate with temperature means the smaller the temperature drift or thermal drift, and it can be understood as being insensitive to temperature change. Therefore, since the sensing surface 144 of the diaphragm 14 receives less mechanical stress, the durability of the strain gauge 25 is improved, and the sensing performance of the strain gauge 25 improves as the temperature drift decreases.

In addition, since the protrusion 118 extending from the bottom of the diaphragm accommodation groove 115 is tapered in a conical shape, when the opened lower surface of the diaphragm 14 is seated on the protrusion 118, since the diaphragm 14 is fixed without shaking, a separate structure for holding the diaphragm 14 is not required during welding.

Specifically, the lower end of the body 141 of the diaphragm 14 is fixed to the diaphragm accommodation groove 115 by welding. At this time, the welding machine contacts the upper surface of the shoulder 142 and the lower end of the body 141 is seated on the bottom of the diaphragm accommodation groove 115. Since the diameter of the lower end part of the protrusion 118 is formed to a side corresponding to the inner diameter of the body 141, in a state where the lower end part of the body 141 is in contact with the bottom of the diaphragm accommodation groove 115, a phenomenon in which the diaphragm 14 vibrates in the radial direction and is eccentric in the radial direction from the center of the diaphragm accommodation groove 115 does not occur. Furthermore, since the upper surface of the diaphragm 14 is pressed by the welding device, the diaphragm does not fluctuate even in the axial direction. Therefore, when the inner and outer edge parts of the lower end part of the body 141 are coupled to the diaphragm accommodation groove 115 by condenser welding, a separate mechanical structure for supporting the diaphragm 14 is not required.

In addition, a boss 146 may protrude from the center of the lower surface of the sensing surface 144. The boss 146 is formed at the center of the sensing surface 144 and is located directly above the communication hole 117. Since the boss 146 is formed, the non-linearity of the strain can be improved by making the strain distribution linearly increase or decrease as the pressure increases or decreases.

FIG. 16 is an enlarged view illustrating a part A of FIG. 15.

Referring to FIG. 16 together with FIG. 15, the groove 145 is recessed to a predetermined depth on the outer circumferential surface of the support part 143 of the diaphragm 14, and the groove 145 may be continuously surrounded in a belt shape on the outer circumferential surface of the support part 143.

In addition, a rounded part 1421 curved with a predetermined curvature may be formed at a corner part where the support part 143 and the shoulder 142 meet. In addition, rounded parts 1451 and 1452 rounded with a predetermined curvature may be formed at the upper and lower end parts of the groove 145, respectively, and the rounded parts 1451 and 1452 may be defined as an upper rounded part 1451 and a lower rounded part 91452, respectively.

Since the rounded parts 1451, 1452, and 1421 are formed, respectively, it is possible to prevent a corner part where the rounded parts are formed from being damaged due to stress concentration.

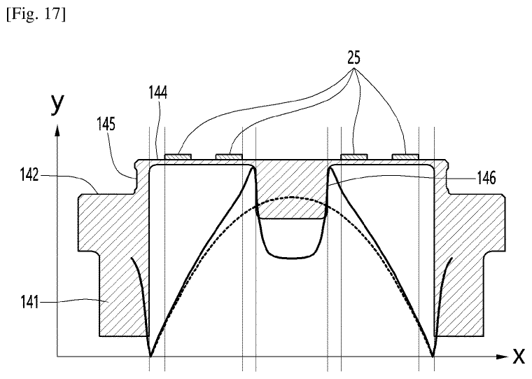

FIG. 17 is a view illustrating a comparison between strain distribution in the case where a boss is present in a diaphragm and strain distribution in the case where a boss is not present in a diaphragm.

For reference, the vertical axis (y-axis) of the strain distribution graph represents the strain output value, and the horizontal axis (x-axis) represents each point of the sensing surface 144.

Referring to FIG. 17, when the boss 146 protrudes from the center of the lower surface of the sensing surface 144, it can be seen that the strain distribution linearly increases or decreases as indicated by a solid line. On the other hand, when there is no boss 146, it can be confirmed that the strain distribution increases or decreases non-linearly as indicated by the dotted line.

In addition, it can be confirmed that the strain output value when the boss 146 is present is greater than the strain output value when the boss 146 is not present. As the strain output value increases, the sensing error rate decreases and the precision improves.

1. A sensor module comprising:
a pressure sensing part for sensing pressure;
at least one or a plurality of PCB substrates for receiving the pressure signal sensed by the pressure sensing part, processing the pressure signal, and then outputting the signal; and
a case accommodating the at least one or a plurality of PCB substrates and coupled to an upper end of the pressure sensing part;
wherein the pressure sensing part includes:
a sensing port in which a communication hole for pressure transmission is formed; and
a pressure sensing element placed on an inner upper side of the sensing port and sensing a change in pressure transmitted through the communication hole;
wherein the pressure sensing element includes:
a diaphragm including a horizontal sensing surface and a support part extending vertically from an edge of the sensing surface; and
one or more strain gauges placed on the sensing surface to sense a change in pressure transmitted through the communication hole; and
wherein the outer circumferential surface of the support part is formed with a groove recessed to a predetermined depth.

2. The sensor module of claim 1, wherein rounded parts are formed in an upper end and a lower end of the groove, respectively.

3. The sensor module of claim 1, wherein the diaphragm further includes:
a shoulder extending in a radial direction from the lower end of the support; and
a body extending downward from a bottom surface of the shoulder, and
wherein inner diameters of the support part, the shoulder, and the body are the same.

4. The sensor module of claim 3, wherein the outer diameter of the body is larger than an outer diameter of the support part and smaller than an outer diameter of the shoulder.

5. The sensor module of claim 1, wherein the diaphragm further includes a boss protruding from a lower surface of the sensing surface.

6. The sensor module of claim 5, wherein the boss protrudes from the center of the sensing surface and is located directly above the communication hole.

7. The sensor module of claim 3, wherein the sensing port includes:
a pot main body in which the communication hole is formed; and
a flange formed on the upper end of the pot main body, and
wherein the diaphragm accommodation groove in which the diaphragm is accommodated is recessed to a predetermined depth from the upper surface of the flange to the lower side.

8. The sensor module of claim 7, wherein the lower end of the body is seated in the diaphragm accommodation groove,
wherein a protrusion protrudes from the bottom of the diaphragm accommodation groove, and
wherein the communication hole passes through the protrusion.

9. The sensor module of claim 8, wherein the protrusion tapers in a direction in which the diameter decreases toward the upper end, and
wherein the inner lower end portion of the body touches the lower end of the protrusion.

10. The sensor module of claim 1, wherein the pressure sensing part further includes a snubber inserted at a lower end of the sensing port.

11. The sensor module of claim 10, wherein a snubber coupling groove is recessed from the lower end to the upper end of the sensing port, and
wherein the lower end of the communication hole is connected to the snubber coupling groove.

12. The sensor module of claim 10, wherein, inside the buffer,
a wrench groove recessed upward from the lower end of the snubber; and
a pressure reducing slit extending from the center of the upper surface of the wrench groove to the upper end of the snubber are formed.

13. The sensor module of claim 11, wherein threads are formed on the outer circumferential surface of the snubber and the inner circumferential surface of the snubber coupling groove, respectively, and thus the snubber is screwed into the snubber coupling groove.

14. The sensor module of claim 9, wherein the lower end of the body is welded to the bottom of the diaphragm accommodation groove.

15. The sensor module of claim 2, wherein the diaphragm further includes:
a shoulder extending in a radial direction from the lower end of the support; and
a body extending downward from a bottom surface of the shoulder, and
wherein inner diameters of the support part, the shoulder, and the body are the same.
